(19) United States
(12) Patent Application Publication
(10) Pub. No.: US 2002/0056302 A1
(43) Pub. Date: May 16, 2002

(54) Thermo-mechanical for garbage treatment

(75) Inventor: Jean-Pierre Tschudi, Jens (CH)

Correspondence Address: DARBY & DARBY P.C., 805 Third Avenue, New York, NY, 10022, US

(73) Assignee: IPETE AG, HOHFUHRENWEG (CH)

(21) Appl. No.: 09/977,503

(22) Filed: Oct. 11, 2001

Related U.S. Application Data
(63) Continuation of application No. 09/000,113, filed on Sep. 3, 1999, now abandoned.

(30) Foreign Application Priority Data
May 22, 1996 (CH) 1349/96
May 21, 1997 (CH) PCT/CH97/00199

(51) Int. Cl. C05F 11/02

(52) U.S. Cl. 71/24

(57) ABSTRACT

A method for continuously treating unsorted municipal waste to produce a high quality, recycled humus, includes the steps of continuously transporting the waste to a liquid containing soaking tank and, en route, magnetically removing ferrous parts and screening out coarse parts beyond a predefined size, and depositing the remainder of the waste in a liquid containing soaking tank to form a slurry, while continuously skimming off floating matter and removing settled out heavy matter. Dried slurry is continuously subjected to thermomechanical treatment involving high mechanical pressure and high frictional and warping forces, so that the temperature thereof is increased substantially and the microorganism content thereof is changed, rendering the resultant material hygienic, practically germ-free, neutral in odor and loose, springy and full in structure. The resultant material is then heaped into piles for aerobic composting.

This application is a continuation of application Ser. No. 09/000,113 filed Sep. 3, 1999, the entirety of which is incorporated herein by reference.

### FIELD OF THE INVENTION

The present invention relates to a continuous method for the treatment of waste incorporating thermomechanical processing.

### BACKGROUND OF THE INVENTION

The disposal of wastes is a constant problem for municipalities since neither landfilling nor garbage incineration, or composting, has proved a satisfactory solution. Experience has shown that the landfill does not provide the solution, just a way of temporarily hiding the problem, and that it is not sensible to incinerate everything which can be incinerated, and not everything which is taken up from compost is beneficial and harmless to nature. Accordingly, an efficient innovation is required in the recycling economy for the disposal of wastes, one which takes account of the complexity of the problems and is finely tuned to requirements, and which can be procured at low cost, is paid off within the foreseeable future and not least is self-sustaining in its operation.

An important attempt at solving this problem is the composting of municipal waste into high-quality recycled humus. It should be appreciated that, as used herein, “municipal” waste is not intended to identify the source of the waste, but a specific category or type of waste. A proposal is known which has been successfully tested in a pilot plant and goes so far as to enlist the help of the waste producers by requiring preselection of the waste. The producer himself must ensure that only pure biowaste free from undesired and harmful substances goes into the garbage collection. For biowaste should strictly speaking not contain any batteries, household chemicals (such as solvents, paints, lacquers and varnishes, plant treatment agents, pesticides, car care agents, old medicines), vacuum cleaner bags, textiles, diapers, cigarette ends, plastics, glass, nor any metals whatsoever. Quality control measures are used to monitor compliance with this demand, in that the collection vehicles operating in a collection area are equipped with detectors in order to be able to refuse to take garbage cans containing harmful and undesired substances, and thereby force the producer to show understanding and the required discipline and cooperation.

As the most recent prior art of composting shows, it is possible to produce a readily usable recycled humus from the biowaste within a reasonable time. To do this, the biowaste is put on a composting site having a sealed covering and aerating and drainage channels and is stacked into piles above the aerating and drainage channels. The piles are furnished with thermometer and oxygen probes, covered with breathable three-layer cover sheeting and aerated by means of fans, as a function of the temperature and the oxygen consumptio, so that there is a permanent excess of oxygen in the pile. The composting time for intensive and post-composting in such facilities amounts to a total of two months, or one-third of conventional facilities with open piles. Recycled humus of good quality comes at a price and is bought for use in agriculture and horticulture.

The example discussed only applies, however, to the organic fraction of the municipal wastes, which makes up proportionately, as a yearly average, not more than half of the municipal wastes. Composting by itself is therefore not a workable solution for the disposal of municipal garbage. It is greatly appreciated by the municipal authorities if people at public meeting places (shopping centers, railway stations, stands at sporting facilities, etc.) use the garbage cans at all. As is known, the garbage arising at these places is unsorted and it is doubtful whether these anonymous waste producers will ever feel enthusiastic about the effort involved with garbage presorting.

The object of the invention is the ecologically and economically optimal disposal of municipal wastes in the context of the recycling economy, it being the intention to dispense with direct employment of human labor for the processing of the supplied materials, for financial, organizational, ethical and, not least, hygienic reasons.

This object is achieved in accordance with the invention by the defining features of claim 1.

Among the advantages obtained by the invention is that, in place of large central facilities, local solutions with correspondingly shorter transportation distances are also possible, that no rescreening of the compost is necessary, and that the composting time is reduced even by comparison with the latest methods and thus the space-requirement of the composting facility is at least halved, or the compost throughput per unit area is at least doubled.

Rendering the compost processing hygienic creates a quality feature in the recycled humus to an unprecedented extent.

By virtue of the fact that the thermomechanical processing supports automated sorting, for example hydromechanical sorting (BTA method), the fully automated processing of unsorted municipal wastes to compost is achieved. The combination of these methods attains the required attributes, since the proposed solution is self-sufficient in terms of energy, is cost-covering with regard to its operation and requires little investment. In other words, by virtue of the fact that the waste slurry free from harmful and undesired substances is thermomechanically processed to the loose, full compost material, there is the possibility of automatic processing of household garbage to compost material, with some of the garbage being convertible into thermal and electrical energy.

The thermomechanically processed material is suitable for composting (maturing and stabilizing) and yields a recycled humus of Maturity Class V and is pleasant-smelling, loose, full and free from any chemicals, additives or nutrients and is outstandingly suitable for improving soils in agriculture and horticulture.

The garbage disposal is self-financing, since the garbage collection fees and the profits from the sale of the high-quality recycled humus, as well as the price of the scrap metals, are sufficient to pay off the plant investment in the medium term and to cover the operating costs.

### BRIEF DESCRIPTION OF THE DRAWING

The invention is explained in more detail and by way of example hereinbelow with reference to the attached drawing of one possible mode of embodiment. In the drawing:

FIG. 1 shows a flow diagram schematically illustrating a preferred method and processing system embodying the invention.

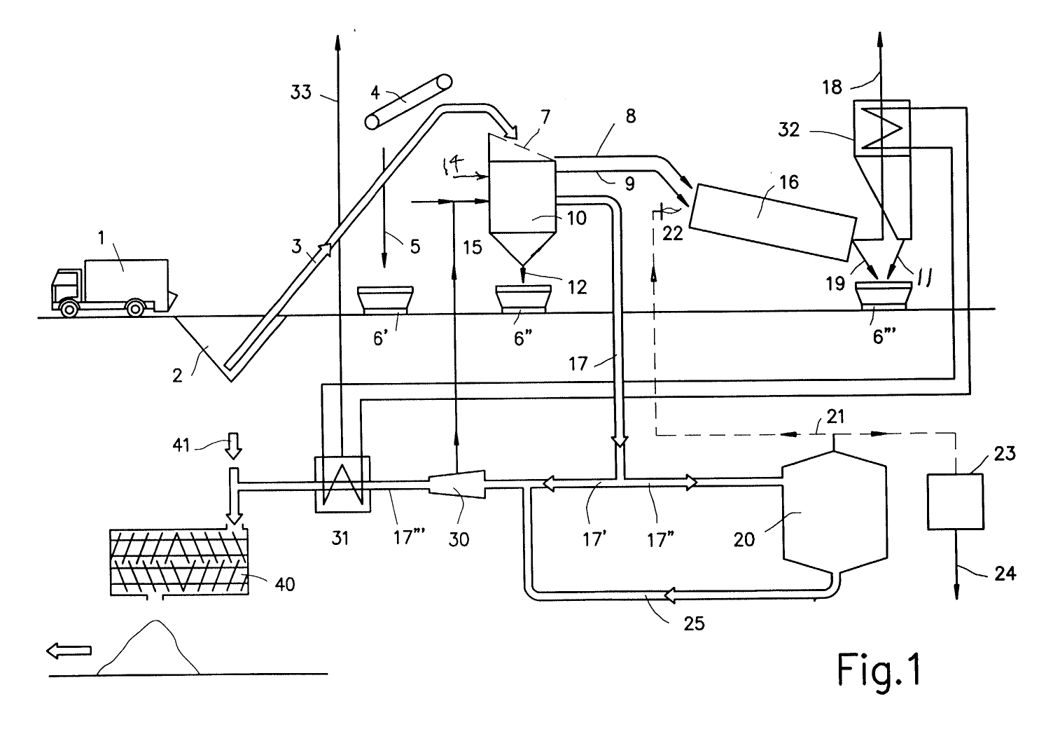

### DETAILED DESCRIPTION OF THE PREFERRED EMBODIMENT

The municipal waste delivered in vehicle 1 is compacted and crushed during collection, so that no bulky parts go into the bunker 2 when the vehicle dumps its load therein. The garbage is conveyed from the bunker 2 on an open conveyor belt 3 through the screen 7 to the soaking tank 10. En route, iron parts 5 are separated out by the magnetic separator 4 and deposited into the collecting container 6′.

Coarse parts 8 (greater than 200×200 millimeters in size) are blocked by the screen 7 and sent on to rotary oven 16. The remainder of the waste passes through screen 7 into the soaking tank 10, which is filled with process water 15 and may be supplemented with fresh water 14, as required. Any floating matter 9 (plastic, wood, textiles) in tank 10 is skimmed off and is discharged into the rotary furnace 16, and the heavy matter 12 (stoneware, glass, sand, nonferrous metals), which settles out is deposited into the collecting container 6″. The material processed in rotary furnace 16 (i.e., coarse parts 8 and floating matter 9 from tank 10) is deposited in container 6′″.

The soaked waste parts are slurried in the soaking tank 10 by the forced flow, to form the suspension 17. A portion 17′ of this suspension 17 is generally fed to a decanter centrifuge 30, where the major part of the process water 15 is removed from the suspension portion 17′ and is re-circulated to the soaking tank 10.

Another portion 17″ of the suspension 17 passes periodically (every two weeks) to a digestion tank 20, where biogas 21 is produced with slow stirring. The biogas 21 is used to generate for the process, as required, electric current 24 via a gas motor/generator 23 or heat by means of the burner 22 in oven 16. Together with the waste gases 18, the burned biogas passes through the rotary furnace 16 and proceeds through the heat exchanger 32, which extracts heat therefrom and transfers it to the drier 31.

Permanent biogas recovery requires at least two digestion tanks 20, which are alternately emptied and filled. The putrefied suspension 25 is combined with the suspension portion 17′ and sent to a decanter centrifuge 30, where it is mechanically dewatered and then thermally dewatered in the drier 31, with evaporation of the exhaust vapors 33, in order to produce a dried waste mass 17′″.

The mass 17″ is subjected to a thermomechanical treatment with vegetable matter 41 in the twin-screw extruder 40. Preferably, the extruder is twin-screw extruder with self-clamping reversible screws and thrust reversal of the mass flow is utilized. As a result of this treatment, the waste/vegetable mixture is crushed so that a virtually homogeneous mixture of new consistency is produced under high mechanical pressure and high frictional and warping forces. This processing leads to an increase in the temperature and a change in the content of microorganisms of the treated materials, so that they are rendered hygienic, practically germ-free and neutral in odor and receive a loose, springy and full structure.

This extruded material is then heaped in piles and subjected to composting. It is particularly suitable as a material for post-composting, because even when heaped to a pile the structure remains loose and full enough during and after composting that the partial input of excess atmospheric oxygen is assured. By using breathable cover sheeting and forced ventilation, the material is converted into high-quality recycled humus of Maturity Class V within a retention time of two to three weeks, without mechanical turnover of the pile and without being an odor nuisance to the environment.

Although preferred embodiments of the invention have been disclosed for illustrative purposes, those skilled in the art will appreciate that many additions, modifications and substitutions are possible, without departing from the scope and spirit of the invention as defined by the accompanying claims.

What is claimed:

1. A method for continuously treating unsorted municipal waste to produce a high quality, recycled humus, comprising the steps of:
continuously transporting the waste to a liquid containing soaking tank and, en route, magnetically removing ferrous parts and screening out coarse parts beyond a predefined size, and depositing the remainder of the waste in a liquid containing soaking tank to form a slurry, while continuously skimming off floating matter and removing settled out heavy matter;
continuously subjecting dried slurry to thermomechanical treatment involving high mechanical pressure and high frictional and warping forces, so that the temperature thereof is increased substantially and the microorganism content thereof is changed, rendering the resultant material hygienic, practically germ-free, neutral in odor and loose, springy and full in structure;
heaping the resultant material into piles for aerobic composting.

2. The method of claim 1, wherein a portion of said slurry is periodically provided to a digestion tank to produce biogas used to, one of: fuel a generator of electric power used in the present method; and fuel a burner utilized in the present method.

3. The method of claim 2, wherein the biogas is used in an oven which burns one of the extracted coarse parts and the floating matter, the exhaust gases from this burning being sent to a heat exchanger, which extracts their heat and provides it at another part of the process.

4. The method of claim 3, wherein prior to the subjecting step, the slurry is dewatered in a drier supplied with heat from said heat exchanger.

5. The method of claim 2, wherein putrefied suspension from digestion tank is combined with the slurry prior to said subjecting step.

6. The method of claim 1, wherein prior to said subjecting step, said slurry is mechanically dewatered, with a major part of the extracted water being returned to the soaking tank.

7. The method of claim 1, wherein prior to said subjecting step, vegetable matter is combined with the dried slurry.

8. The method of claim 1, wherein the subjecting step is performed with a twin-screw extruder.

9. The method of claim 8, wherein the extruder has self-clamping reversible screws and utilizes thrust reversal of mass flow.

10. The method of claim 1, wherein one pile is covered with breathable cover sheeting and is subjected to forced ventilation, the material being converted into high-quality recycled humus of Maturity Class V within a retention time of two to three weeks, without mechanical turnover of the pile and without being an odor nuisance to the environment.
